(19) United States
(12) Patent Application Publication
(10) Pub. No.: US 2012/0187035 A1
(43) Pub. Date: Jul. 26, 2012

(54) Screen For A Bandscreen

(75) Inventor: Nigel Shepherd, Ross on Wye (GB)

(73) Assignee: The Haigh Engineering Company Limited, Herefordshire (GB)

(21) Appl. No.: 13/357,855

(22) Filed: Jan. 25, 2012

(30) Foreign Application Priority Data
Jan. 26, 2011 (GB) 11 01 318.2

(51) Int. Cl. B01D 35/28; B23P 11/00

(52) U.S. Cl. 210/236; 210/499; 29/428

(57) ABSTRACT

A screen for a bandscreen including a support frame and two or more perforated screening panels each of which is releasably attached to the support frame so as to be independently detachable from the support frame.

### BACKGROUND

The present invention relates to bandscreens in the form of an endless belt of screens and, more particularly, a screen suitable for such a bandscreen.

These are used, for example, to remove solid material carried by a stream of effluent. The effluent is transported to the interior of the bandscreen, the liquid passes through the screens which retain solid materials down to a size determined by the dimensions of filter holes in the screens.

The bandscreen is generally arranged so that when the belt of screens is rotated the screens are lifted out of the effluent, in turn, to the top of the assembly where the solid material falls off and so is removed for disposal.

In one known arrangement, as exemplified by the bandscreen disclosed by GB-B-2,403,438, there are a pair of spaced-apart endless drive chains to which are bolted a number of screens with no inter-engagement between screens. The chains are driven into rotation and the screens are carried round by the chains. This arrangement allows the ends of screens to move relative to each other to adopt a stepped profile at a selected region which in turn compromises sealing between the panels when positioned to screen the effluent.

In another known arrangement, as exemplified by GB-B-2,407,782, the bandscreen includes a series of screens linked together at their edges by hinge and pin joints to form the endless belt of screens. The belt is rotated by driving the topmost ones of linking pins that link the screens together, the driving force being transmitted between successive screens. This arrangement is said to provide a bandscreen of reduced component count by eliminating the need for a chain drive and the use of the hinged joints provides sealing between adjacent screens whilst providing the relative articulation needed to enable the bandscreen to adopt a suitably tight curve over the driving mechanism whilst being substantially coplanar when in the screening position.

A further known arrangement of bandscreen is disclosed by the present applicant's earlier European patent application publication number EP 2 030 663 published 4 Mar. 2009. The individual screens of this bandscreen are as shown in FIGS. 1 and 2 of this application and are as described below.

When such a screen has to be replaced because of normal wear or damage, it is necessary to remove the screen from the bandscreen which is a time consuming process.

### SUMMARY

The present invention provides a screen for a bandscreen including a support frame and at least one perforated screening panel each of which is releasably attached to the support frame so as to be independently detachable from the support frame. Because there are detachable screening panels the screen frame repairs are easier to carry out so reducing the costs and equipment down time associated with repairing and replacing screens. This is because the support frame can stay fully attached to the bandscreen while only a screen panel needs to be removed and replaced. In the prior art arrangement the entirety of the screen had to removed and replaced even if only a part was damaged.

Preferably the screen includes two or more perforated screening panels each of which is releasably attached to the support frame so as to be independently detachable from the support frame. This allows only that section of the perforated portion of the screen that is damaged, for example, to be selectively removed rather than all the perforated part of the screen if there is only one detachable screening panel. The number of screening panels can be chosen according to the width of the screen as considered convenient.

Preferably each screening panel is releasably attached to the support frame by a quick release (e.g., quarter-turn) fastener but other suitable releasable fixing means may be used. Such fasteners can be locked and unlocked much faster than conventional screw fasteners, for example.

### BRIEF DESCRIPTION OF THE DRAWINGS

Embodiments of the invention will now be described, by way of example only, with reference to the accompanying drawings of which:

FIG. 1 is a diagrammatic isometric view of a screen of a prior art screen for a bandscreen;

FIG. 2 is a diagrammatic end view of the screen of FIG. 1;

FIG. 3 is a diagrammatic exploded isometric view of an embodiment of a screen according to the present invention;

FIG. 4 is a diagrammatic partial reverse view of the exploded portion of FIG. 3;

FIG. 5 is a top view of an embodiment of a screen, with one screen panel removed for clarity;

FIG. 6 is a view of the screen taken along line A-A of FIG. 5;

FIG. 7 is a view of the screen taken along line B-B of FIG. 5;

FIG. 8 is an enlarged view of portion C shown in FIG. 6;

FIG. 9 is an enlarged view of portion D shown in FIG. 7;

FIG. 10 is an enlarged view of portion E shown in FIG. 5;

FIG. 11 is an enlarged view of portion F shown in FIG. 6; and

FIG. 12 is an exploded view of a bandscreen in accordance with certain embodiments.

### DETAILED DESCRIPTION

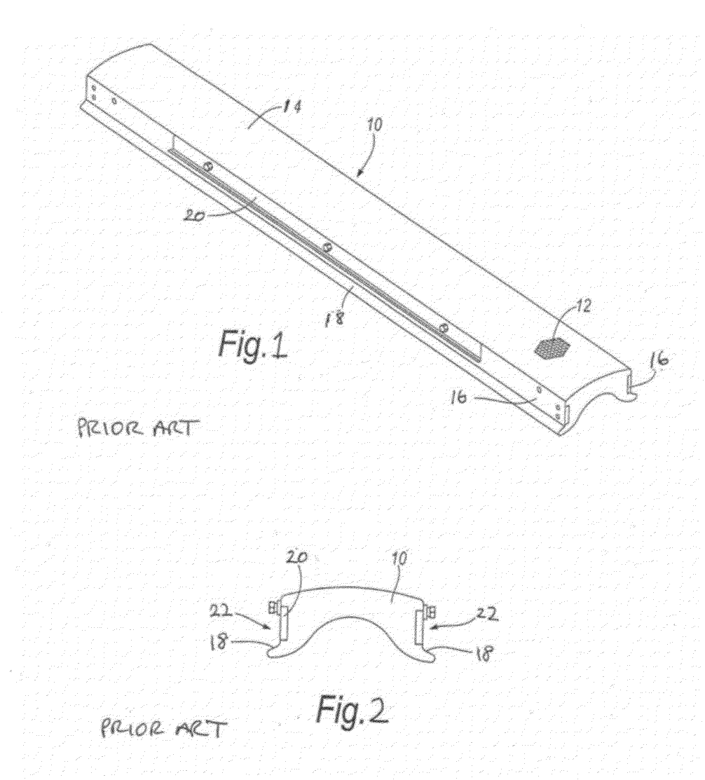

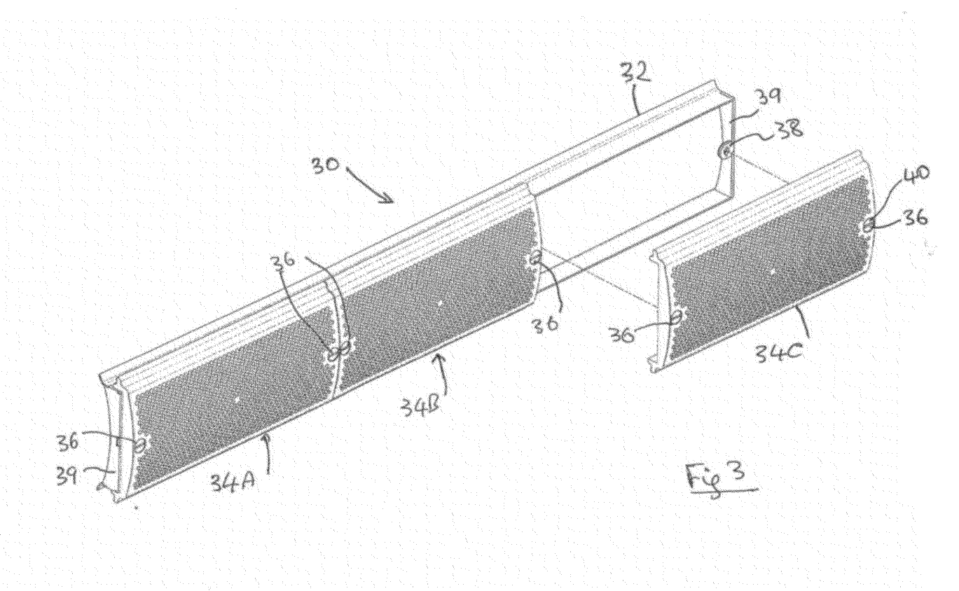

Referring to FIGS. 1 and 2, a prior art screen has a perforated elongate screening area 14 substantially covered in perforations 12 of which only a few are shown for clarity reasons. Sidewalls 16 extend vertically downward (in the orientation illustrated) from the screening area along each longitudinal edge and terminate in a lip 18 that extends downwardly and outwardly from vertical sidewall. Bolted on to each sidewall 16 is a bracket 20 which, with the lip 18 and a portion of the sidewall 16 between the lip 18 and the bracket 20, defines a channel 22 engageable by a supporting link of a bandscreen (not shown) and in the manner described in EP 2 030 663 the entire contents of which are incorporated in the present application by reference.

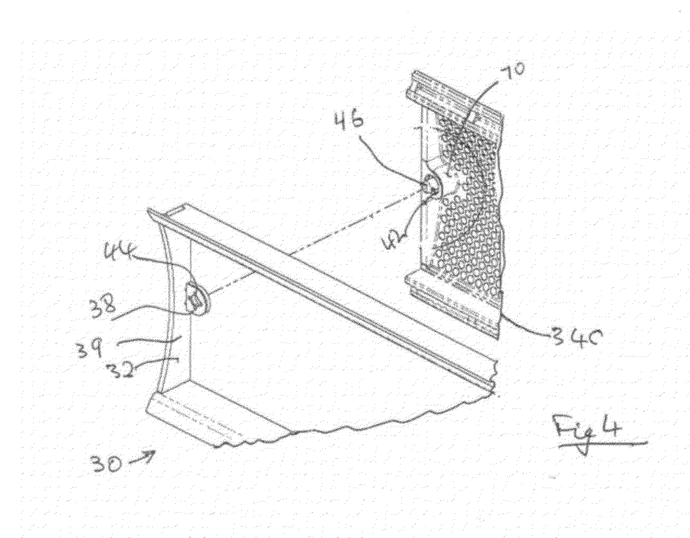

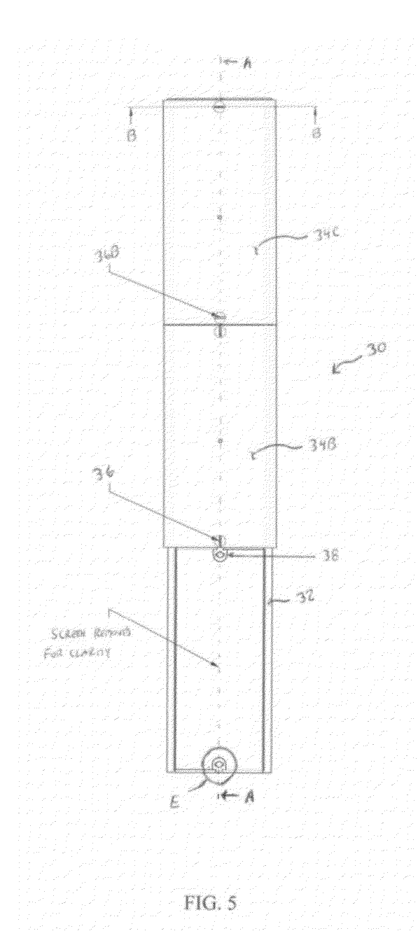

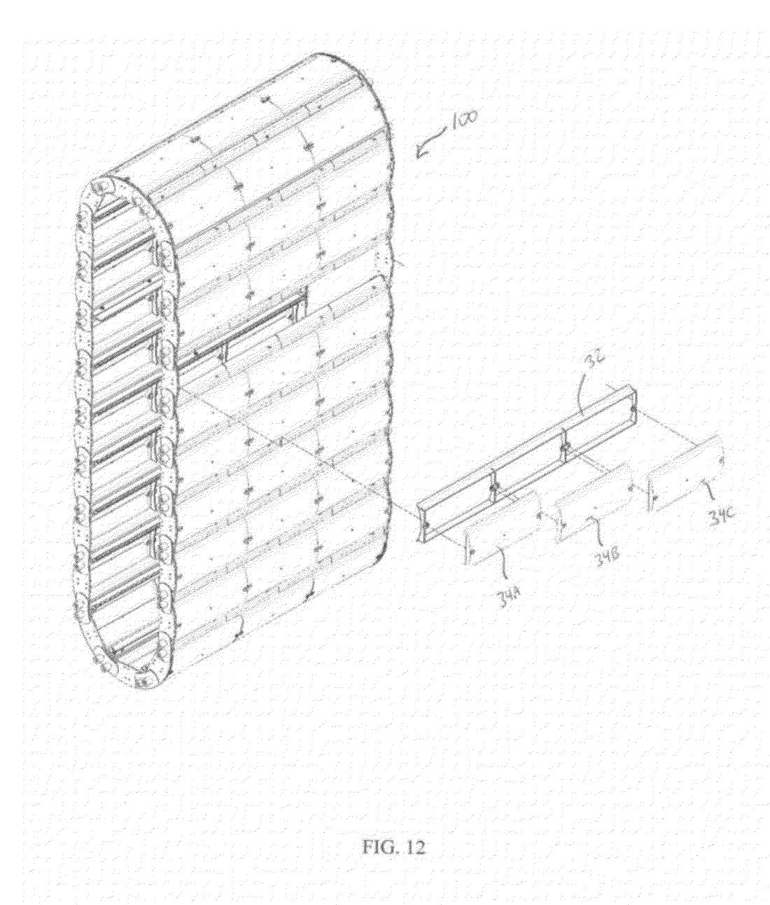

Referring now to FIGS. 3, 5 and 6, there is shown an embodiment of the present invention, namely a screen 30 for a bandscreen 100 (FIG. 12) which includes a support frame 32 to which, in this particular embodiment, are releasably attached three discrete screening panels 34A, 34B and 34C by quick release (e.g., quarter-turn) fasteners 36 each engageable with a respective locking tab 38.

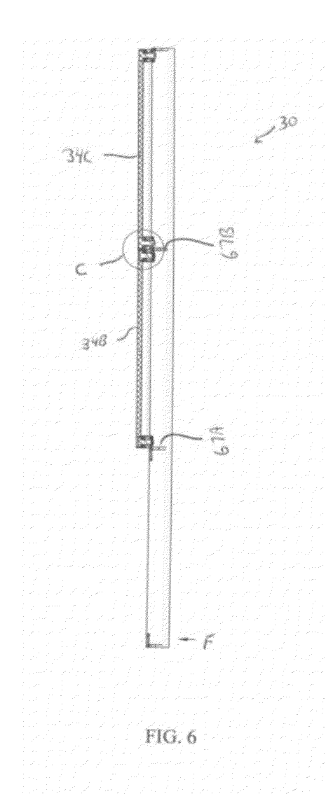

In certain embodiments, the support frame 32 is generally rectangular with locking tabs 38 fixed to end walls 39 and two cross beams 67A, 67B (FIG. 6) that are parallel to the end walls 39 and equidistantly spaced along the support frame 32.

The screening panels 34A, 34B and 34C may be manufactured by any convenient known manner including moulding the entire screening panel in a suitable plastics material or moulding a plastics material about a perforated metal insert.

In the illustrated embodiment the quick release fasteners 36 comprise fastening members having notched heads 40 so as to turnable by a screwdriver, and an axially extending shaft 46. Stub or stubs 42 (FIG. 4) extend outwards from opposite sides of the shaft 46 and which are oriented so they are able to pass through corresponding cuts 44 of a tab 38 and to secure the fastener 36 to the tab 38, positioned on the underside of the support frame 32, when rotated. This provides that the screens 34A, 34B and 34C can be independently unfastened and removed from the support frame 32 for repair or replacement. Thus, the fastener 36 and the tab 38 are arranged to cooperate to form a quick release fastener assembly.

As best seen in FIG. 8, the quick release fastener 36A for panel 34B is shown in the locked position, whereas the quick release fastener 36B for panel 34C is shown in the unlocked position.

In certain embodiments, each fastener 36 is positioned in a bore in fastener holder member 70 that is formed in the underside of the screens 34A, 34B, 34C (FIG. 3). The bore has an upper region 71 of larger diameter than a lower region 72, the upper region 72 accommodating the fastener head 40 and biasing member 61, and the lower region 72 accommodating the shaft 46 of the fastener 36.

In certain embodiments, a biasing member 61, such as a coil spring, is positioned beneath the head 40 of each quick release fastener 36 and seats in the shoulder 73 of the fastener holder member 70 as shown, and functions to bias the fastener 36 in an axially upward direction.

Each quick release fastener 36 is locked by overcoming the biasing force of the biasing member 61, pushing the fastener axially downward, and twisting the fastener (e.g., 90°, depending upon the initial orientation of the fastener) to position the stub 42 in radial groove 66 of the tab 38 (FIG. 11) upon release of the fastener. The biasing member 61 then functions to retain the fastener 36 in this locked position by biasing the fastener axially upwardly.

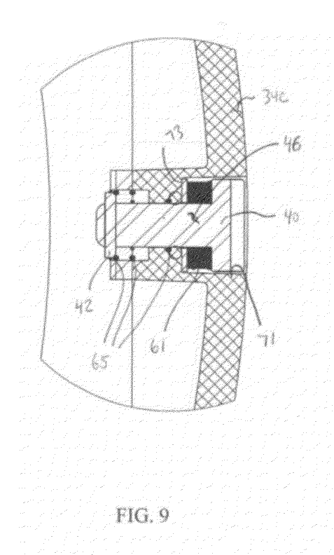

To unlock the fastener 36, it is again pushed axially downward and rotated (e.g.,) 90°, allowing the stub 42 to exit the groove 66 and pass through the cuts 44 in the tab 38. As shown in FIG. 9, various O-rings or the like can be positioned to seal the fastening member.

Those skilled in the art will appreciate that while the embodiment illustrated includes two spaced fasteners 36 for each panel, fewer or more could be used without departing from the spirit and scope of the embodiments disclosed herein. In addition, the location of the fasteners, while shown at opposite ends of each panel, is not so limited.

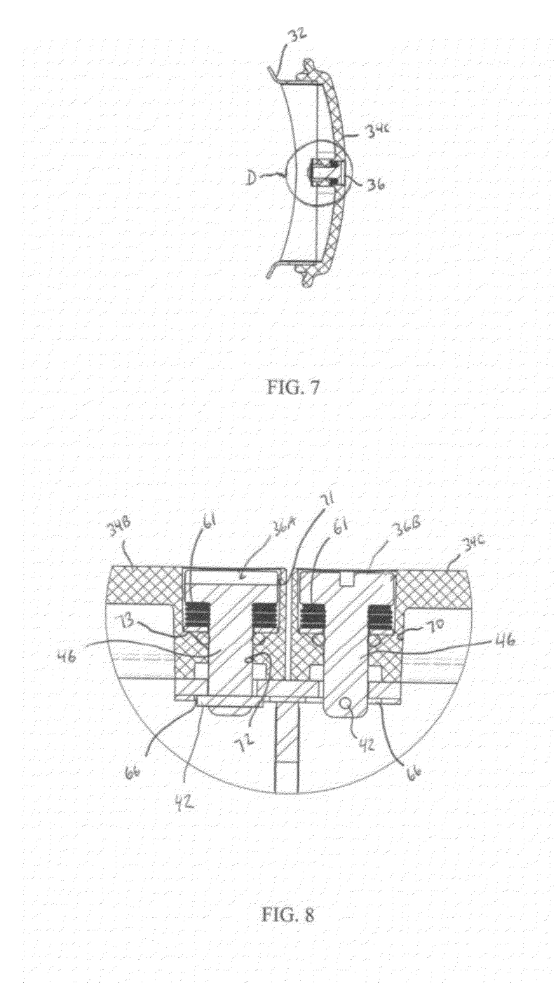

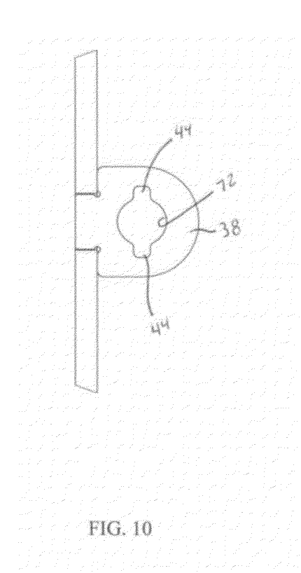

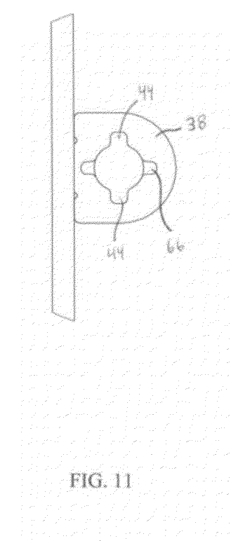

Those skilled in the art will also appreciate that while the embodiment of FIGS. 6-12 show a fastener with a single stub 42 extending radially in two directions, two or more stubs 42 could be used to achieve a similar result.

In operation, a perforated screen panel can be releasably attached to a support frame of a screen for a bandscreen by providing a perforated screen panel having a fastener holder and a fastener positioned in the holder. In certain embodiments the fastener comprises a head and a shaft extending axially therefrom, the shaft having at least one stub extending radially therefrom. A support frame having a tab is also provided, the tab having an aperture for receiving the shaft of the fastener, and a groove for receiving the at least one stub. The perforated screen panel is positioned on the support frame so that the fastener and tab are aligned for operative engagement. A force (e.g., downward and rotational) is applied to the fastener to cause the at least one stub to mate with the groove in the tab to cause the tab and the fastener to be in locking engagement, thereby securing the perforated screen panel to the support frame. In certain embodiments, the stub is caused to lockingly engage with the groove by biasing the fastener axially upwardly.

To unlock the perforated screen panel from the support frame, a force (e.g., rotational) is applied to the fastener to cause the at least one stub to unmate or disengage with the groove. The screen then can be readily removed from the frame and repaired or replaced.

1. A screen for a bandscreen including a support frame and at least one perforated screening panel each of which is releasably attached to the support frame so as to be independently detachable from the support frame.

2. A screen for a bandscreen as claimed in claim 1, including two or more perforated screening panels.

3. A screen as claimed in claim 1, in which each screening panel is releasably attached to the support frame by a quick release fastener assembly, said assembly comprising a tab and a fastener cooperatively arranged to releasably attach said at least one perforated screen panel to said support frame, said fastener comprising a head and a shaft extending axially therefrom; said tab comprising an aperture for receiving said shaft.

4. The screen as claimed in claim 3, wherein said fastener assembly further comprises a biasing member for axially biasing said fastener with respect to said tab.

5. The screen as claimed in claim 3, wherein said fastener is movable between a screen panel locked position and a screen panel unlocked position.

6. The screen as claimed in claim 3, wherein said tab further comprises a groove, and said fastener further comprises a stub extending radially from said shaft, wherein said stub is received in said groove when said fastener is in a locked position in said tab.

7. A method of releasably attaching a perforated screen panel to a support frame of a screen for a bandscreen, said method comprising:
providing a perforated screen panel having a fastener holder and a fastener positioned in said holder, said fastener comprising a head and a shaft extending axially therefrom, said shaft having at least one stub extending radially therefrom;
providing a support frame having a tab, said tab having an aperture for receiving said shaft, and a groove for receiving said at least one stub;
positioning said perforated screen panel on said support frame so said fastener and tab are aligned for operative engagement;
applying a force to said fastener to cause said at least one stub to mate with said groove to cause said tab and said fastener to be in locking engagement, thereby securing said perforated screen panel to said support frame.

8. The method of claim 7, wherein said stub is caused to lockingly engage with said groove by biasing said fastener axially.

9. The method of claim 7, further comprising releasing said perforated screen panel from said support frame by applying a force to said fastener to cause said at least one stub to unmate with said groove.
